(19) United States
(12) Patent Application Publication
(10) Pub. No.: US 2023/0213353 A1
(43) Pub. Date: Jul. 6, 2023

(54) METHOD OF UPDATING ROAD INFORMATION, ELECTRONIC DEVICE, AND STORAGE MEDIUM

(71) Applicant: Beijing Baidu Netcom Science Technology Co., Ltd., Beijing (CN)

(72) Inventors: Deguo XIA, Beijing (CN); Jizhou HUANG, Beijing (CN); Jianzhong YANG, Beijing (CN); Yanlei GU, Beijing (CN); Zhen LU, Beijing (CN); Tingting CAO, Beijing (CN); Qiuyang XU, Beijing (CN)

(21) Appl. No.: 18/183,003

(22) Filed: Mar. 13, 2023

(30) Foreign Application Priority Data
Mar. 14, 2022 (CN) 202210249346.X

(51) Int. Cl. G01C 21/00; G06T 7/10; G06T 5/00

(52) U.S. Cl. CPC G01C 21/3815; G06T 7/10; G06T 5/002

(57) ABSTRACT

A method of updating a road information, an electronic device, and a storage medium, which relate to an artificial intelligence technology field, in particular to fields of computer vision, deep learning, big data, high-definition map, intelligent transportation, automatic driving and autonomous parking, cloud service, Internet of Vehicles and intelligent cabin technologies. The method includes: processing image data corresponding to a target road region to obtain a set of first road lines; obtaining a set of second road lines according to a trajectory map corresponding to the target road region; calibrating the set of first road lines by using the set of second road lines to obtain a set of third road lines; combining the set of third road lines and a set of historical road lines corresponding to the target road region to obtain a combination result; and updating the set of historical road lines according to the combination result.

This application claims priority to Chinese Patent Application No. 202210249346.X, filed on Mar. 14, 2022, the entire content of which is incorporated herein in its entirety by reference.

### TECHNICAL FIELD

The present disclosure relates to a field of an artificial intelligence technology, in particular to fields of computer vision, deep learning, big data, high-definition map, intelligent transportation, automatic driving and autonomous parking, cloud service, Internet of Vehicles and intelligent cabin technologies, and more specifically, to a method of updating a road information, an electronic device, and a storage medium.

### BACKGROUND

With a rapid development of a road construction, a complexity of a road network is also increasing. A user's travel is increasingly dependent on a navigation application, and an accuracy of a positioning of a navigation application may affect a user's travel experience. An accuracy of a road information in the navigation application may affect the accuracy of the positioning of the navigation application.

### SUMMARY

The present disclosure provides a method of updating a road information, an electronic device, and a storage medium.

According to an aspect of the present disclosure, a method of updating a road information is provided, including: processing image data corresponding to a target road region to obtain a set of first road lines; obtaining a set of second road lines according to a trajectory map corresponding to the target road region; calibrating the set of first road lines by using the set of second road lines to obtain a set of third road lines; combining the set of third road lines and a set of historical road lines to obtain a combination result, where the set of historical road lines corresponds to the target road region; and updating the set of historical road lines according to the combination result.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method as described above.

According to another aspect of the present disclosure, a non-transitory computer-readable storage medium having computer instructions therein is provided, and the computer instructions are configured to cause a computer system to implement the method as described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 schematically shows an exemplary system architecture to which a method and an apparatus of updating a road information may be applied according to embodiments of the present disclosure;

FIG. 2 schematically shows a flowchart of a method of updating a road information according to embodiments of the present disclosure;

FIG. 3A schematically shows an exemplary schematic diagram of a process of updating a road information according to embodiments of the present disclosure;

FIG. 3B schematically shows an exemplary schematic diagram of an information related to a set of fourth road lines according to an embodiment of the present disclosure;

FIG. 3C schematically shows an exemplary schematic diagram of an information related to a set of sixth road lines according to an embodiment of the present disclosure;

FIG. 3D schematically shows an exemplary schematic diagram of a set of first road lines according to an embodiment of the present disclosure;

FIG. 3E schematically shows an exemplary schematic diagram of a combination process of a set of third road lines and a set of historical road lines according to an embodiment of the present disclosure;

FIG. 3F schematically shows an exemplary schematic diagram of a combination result according to an embodiment of the present disclosure;

FIG. 4 schematically shows an exemplary schematic diagram of a process of updating a road information according to another embodiment of the present disclosure;

FIG. 5 schematically shows a block diagram of an apparatus of updating a road information according to an embodiment of the present disclosure; and

FIG. 6 schematically shows a block diagram of an electronic device suitable for implementing a method of updating a road information according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

With a rapid development of a road construction, a road network is also changing with each passing day. However, an access to a changed road information is limited. The changed road information may not be made public, which may lead to an inaccuracy of partial road information in a navigation application. For example, road lines are missing or redundant.

From the perspective of user navigation experience, the inaccuracy of the road information may affect a user experience. For example, in a case of missing road lines, a user may detour or a destination may be unreachable.

From the perspective of application, a high-definition map is indispensable in an automatic driving, and a road information of the high-definition map is a basis for escorting automatic driving. The inaccuracy of the road information may lead to a serious safety risk. For example, in a case of missing or redundant road lines, a detected field is inconsistent with that recorded in a system, and a misjudgment or a difficulty in recognition may occur in the automatic driving, which may lead to a traffic accident.

Based on the above content, there is a strong demand for how to effectively ensure an accuracy of the road information. Therefore, embodiments of the present disclosure propose a solution of updating the road information, and the solution includes: processing image data corresponding to a target road region to obtain a set of first road lines; obtaining a set of second road lines according to a trajectory map corresponding to the target road region; calibrating the set of first road lines by using the set of second road lines to obtain a set of third road lines; combining the set of third road lines and a set of historical road lines to obtain a combination result, where the set of historical road lines corresponds to the target road region; and updating the set of historical road lines according to the combination result.

A road line may be extracted from the image data by using the set of first road lines obtained through an image processing and the set of second road lines obtained through a trajectory processing in combination with the set of historical road lines corresponding to a basic road network, and then the set of historical road lines is updated, so as to achieve a multi-source determination of road lines. Therefore, an accuracy and a coverage of a road information update may be improved, and an accuracy and a coverage of the navigation application may be improved.

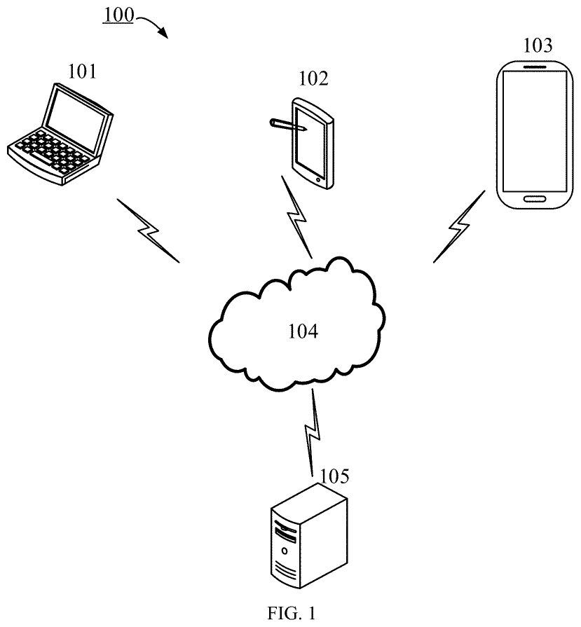

FIG. 1 schematically shows an exemplary system architecture to which a method and an apparatus of updating a road information may be applied according to an embodiment of the present disclosure.

It should be noted that FIG. 1 is only an example of a system architecture to which embodiments of the present disclosure may be applied, so as to help those of ordinary skilled in the art understand the technical content of the present disclosure, but it does not mean that embodiments of the present disclosure may not be applied to other devices, systems, environments or scenarios. For example, in another embodiment, the exemplary system architecture to which the method and the apparatus of updating the road information may be applied may include a terminal device. The terminal device may implement the method and apparatus of updating the road information provided by embodiments of the present disclosure without interacting with a server.

As shown in FIG. 1, a system architecture 100 according to the embodiment may include terminal devices 101, 102, 103, a network 104, and a server 105. The network 104 is a medium used to provide a communication link between the terminal devices 101, 102, 103 and the server 105. The network 104 may include various connection types, such as wired and/or wireless communication links, etc.

The terminal devices 101, 102, 103 used by a user may interact with the server 105 via the network 104, so as to receive or send messages, etc. Various communication client applications may be installed on the terminal devices 101, 102 and 103, such as a knowledge reading application, a web browser application, a search application, an instant messaging tool, an email client and/or a social platform software, etc., (for example only).

The terminal devices 101, 102, 103 may be various electronic devices having display screens and supporting web browsing, including but not limited to smartphones, tablet computers, laptop computers, desktop computers, etc.

The server 105 may be a server that provides various services. For example, the server 105 may be a cloud server, also known as a cloud computing server or a cloud host, which is a host product in a cloud computing service system to solve shortcomings of difficult management and weak business scalability existing in an existing physical host and VPS (Virtual Private Server) service. The server 105 may also be a server of a distributed system, or a server combined with a block-chain.

A background management server (for example only) provides a support for a content browsed by the user using the terminal devices 101, 102, 103. The background management server may analyze and process a received user request and other data, and feed back a processing result (e.g., web page, information or data acquired or generated according to the user request) to the terminal devices.

It should be noted that the method of updating the road information provided by embodiments of the present disclosure may generally be performed by the server 105. Accordingly, the apparatus of updating the road information provided by embodiments of the present disclosure may generally be provided in the server 105. The method of updating the road information provided by embodiments of the present disclosure may also be performed by a server or a server cluster that is different from the server 105 and capable of communicating with the terminal devices 101, 102, 103 and/or the server 105. Accordingly, the apparatus of updating the road information provided by embodiments of the present disclosure may also be provided in the server or server cluster different from the server 105 and capable of communicating with the terminal devices 101, 102, 103 and/or the server 105.

Alternatively, the method of updating the road information provided by embodiments of the present disclosure may generally be performed by the terminal device 101, 102, or 103. Accordingly, the apparatus of updating the road information provided by embodiments of the present disclosure may also be provided in the terminal device 101, 102, or 103.

It should be understood that the number of terminal devices, networks and servers shown in FIG. 1 is only schematic. According to implementation needs, any number of terminal devices, networks and servers may be provided.

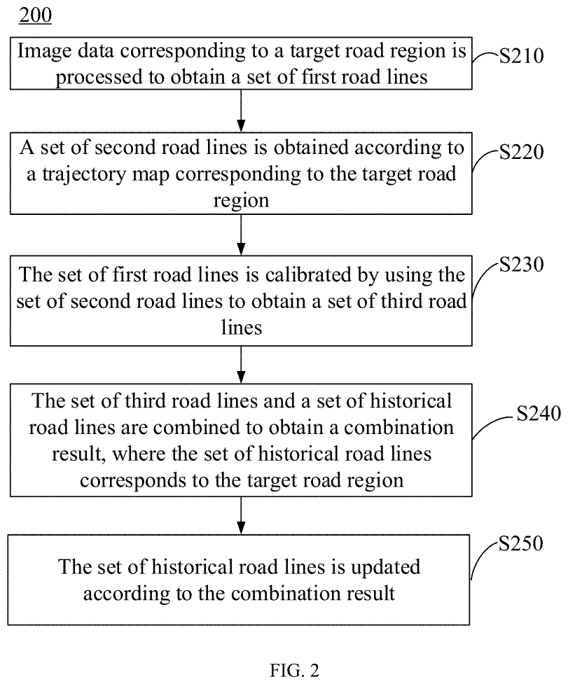

FIG. 2 schematically shows a flowchart of a method of updating a road information according to an embodiment of the present disclosure.

As shown in FIG. 2, the method includes operations S210 to S250.

In operation S210, image data corresponding to a target road region is processed to obtain a set of first road lines.

In operation S220, a set of second road lines is obtained according to a trajectory map corresponding to the target road region.

In operation S230, the set of first road lines is calibrated by using the set of second road lines to obtain a set of third road lines.

In operation S240, the set of third road lines and a set of historical road lines are combined to obtain a combination result, where the set of historical road lines corresponds to the target road region.

In operation S250, the set of historical road lines is updated according to the combination result.

According to embodiments of the present disclosure, the target road region may refer to a road region where a road line needs to be acquired. The set of first road lines may include at least one road line. The trajectory map may be constructed based on a user trajectory. The set of second road lines may include at least one road line. The set of third road lines may be determined according to the set of first road lines and the set of second road lines. The set of historical road lines may refer to road lines that already exist in practice. The set of historical road lines may be used as a basis for updating the road line. The image data may refer to image data for a road.

According to embodiments of the present disclosure, the image data corresponding to the target road region may be processed by using an image processing model, so as to obtain the set of first road lines. For example, it is possible to perform a road line extraction on the image data by using the image processing model, so as to obtain the set of first road lines. The image processing model may include an image segmentation model and/or a graph model. The image segmentation model may include a semantic segmentation model, an instance segmentation model, or a scene segmentation model. It is possible to determine at least one trajectory density peak of the trajectory map, and to determine a point corresponding to each of the at least one trajectory density peak as a trajectory point. The set of second road lines is determined according to at least one trajectory point. For example, connecting the at least one trajectory point to obtain the set of second road lines.

According to embodiments of the present disclosure, after the set of first road lines and the set of second road lines are obtained, the set of first road lines may be calibrated by using the set of second road lines, so as to obtain a calibrated set of first road lines. The calibrated set of first road lines is determined as the set of third road lines. For example, it is possible to determine, from the set of first road lines, a set of road lines matched with the set of second road lines as the set of third road lines.

According to embodiments of the present disclosure, after the set of third road lines is obtained, the set of third road lines and the set of historical road lines may be combined to obtain the combination result. For example, it is possible to determine to change the set of road lines and/or to update the set of road lines according to the set of historical road lines and the set of third road lines. After the combination result is obtained, the set of historical road lines may be updated according to the combination result.

According to embodiments of the present disclosure, a road line may be extracted from the image data by using the set of first road lines obtained through an image processing and the set of second road lines obtained through a trajectory processing in combination with the set of historical road lines corresponding to a basic road network, and then the set of historical road lines is updated, so as to achieve a multi-source determination of road lines. Therefore, an accuracy and a coverage of a road information update may be improved, and an accuracy and a coverage of the navigation application may be improved.

According to embodiments of the present disclosure, operation S210 may include the following operations.

An image segmentation is performed on the image data corresponding to the target road region to obtain a road region image segmentation result. A road line extraction is performed on the road region image segmentation result to obtain a set of fourth road lines. The set of fourth road lines is determined as the set of first road lines.

According to embodiments of the present disclosure, the image data corresponding to the target road region may be input into the image segmentation model to obtain the road region image segmentation result. The image segmentation model may be obtained by training a first predetermined model, and the first predetermined model is trained using first sample image data corresponding to a first sample road region and a sample road region label. The first predetermined model may include a semantic segmentation model, an instance segmentation model, or a scene segmentation model. For example, the first predetermined model may include DFANet (Deep Feature Aggregation for Real-Time Semantic Segmentation), PSPNet (Pyramid Scene Parsing Network), BiSeNet (Bilateral Segmentation Network for Real-time Semantic Segmentation) or OCRNet (Object Contextual Representations for Semantic Segmentation).

According to embodiments of the present disclosure, after the road region image segmentation result is obtained, a de-noising processing, a road skeleton extraction, and a thinning vectorization may be performed on the road region image segmentation result sequentially to obtain the set of fourth road lines.

According to embodiments of the present disclosure, operation S210 may further include the following operations.

The image data corresponding to the target road region is processed by using a predetermined topology map, so as to obtain a set of fifth road lines. The set of fifth road lines is processed to obtain a set of sixth road lines. And, the set of fourth road lines and the set of sixth road lines are combined to obtain the set of first road lines.

According to embodiments of the present disclosure, the predetermined topology map may be a graph model. The graph model may be obtained by training a second predetermined model, and the second predetermined model is trained using second sample image data corresponding to a second sample road region. The second predetermined model may include a graph neural network model, a graph convolution network model, a graph auto-encoder, a graph recurrent neural network model, or a graph reinforcement learning model.

According to embodiments of the present disclosure, the image data is input into the graph model to obtain the set of fifth road lines. After the set of fifth road lines is obtained, a thinning processing and the thinning vectorization may be performed on the set of fifth road lines sequentially to obtain the set of sixth road lines.

According to embodiments of the present disclosure, after the set of fourth road lines and the set of sixth road lines are obtained, the set of fourth road lines and the set of sixth road lines may be combined to obtain the set of first road lines. For example, a different road line between the set of fourth road lines and the set of sixth road lines may be retained. A set of target similar road lines in a set of similar road lines is retained. And the set of first road lines is obtained.

According to embodiments of the present disclosure, by combining the set of fourth road lines and the set of sixth road lines to obtain the set of first road lines, an accuracy and a coverage of determining a road line from the image data may be improved.

According to embodiments of the present disclosure, operation S210 may include the following operations.

The image data corresponding to the target road region is processed by using the predetermined topology map, so as to obtain the set of fifth road lines. The set of fifth road lines is processed to obtain the set of sixth road lines. The set of sixth road lines is determined as the set of first road lines.

According to embodiments of the present disclosure, the set of sixth road lines may be directly determined as the set of first road lines.

According to embodiments of the present disclosure, the performing a road line extraction on the road region image segmentation result to obtain a set of fourth road lines may include the following operations.

A road skeleton extraction is performed on the road region image segmentation result to obtain a set of seventh road lines. The set of seventh road lines is processed by using a first trajectory point thinning algorithm, so as to obtain the set of fourth road lines.

According to embodiments of the present disclosure, the road region image segmentation result may be processed by using a skeleton extraction algorithm, so as to obtain the set of seventh road lines. Skeleton extraction (i.e., binary image thinning) may refer to thinning a connected region to a width of one pixel for a feature extraction and an object topology representation. The skeleton extraction algorithm may include a morphology-based skeleton extraction algorithm. The morphology-based skeleton extraction algorithm may include a Hit Miss Transformation-based skeleton extraction algorithm or a Medial Axis Transformation-based skeleton extraction algorithm, for example, a K3M algorithm, it is set to start burning from a boundary of an object in a binary image, the object may be gradually thinned, and during a burning process, it is necessary to ensure that a pixel meeting a predetermined condition is retained or “burned”. When an end of the burning is determined, the last remaining binary image is a skeleton of the binary image.

According to embodiments of the present disclosure, a trajectory point thinning algorithm may refer to reducing the number of trajectory points while ensuring that a shape of a vector curve meets the predetermined condition. That is, the trajectory point thinning algorithm may be used to simplify the trajectory points of the vector curve. The trajectory point thinning algorithm may include a Douglas-Peucker algorithm, a vertical distance limit algorithm, or a clustering algorithm.

According to embodiments of the present disclosure, the road region image segmentation result may be processed by using the morphology-based skeleton extraction algorithm, so as to obtain the set of seventh road lines. Before the image segmentation is performed on the road region image segmentation result, the road region image segmentation result may be processed to obtain a binarized road region image segmentation result, that is, binary image data. The binary image data may be processed by using the morphology-based skeleton extraction algorithm, so as to obtain the set of seventh road lines.

According to embodiments of the present disclosure, the first trajectory point thinning algorithm may include the Douglas-Peucker algorithm. After the set of seventh road lines is obtained, the set of seventh road lines may be processed by using the Douglas-Peucker algorithm, so as to obtain the set of fourth road lines. That is, a, for each road line included in the set of seventh road lines, a first trajectory point and a second trajectory point on that road line are determined, where the first trajectory point is a trajectory point at the head of that road line, and the second trajectory point is a trajectory point at the tail of that road line; b, the first trajectory point and the second trajectory point are connected to obtain a connection line; c, vertical distances between other trajectory points on the road line and the connection line are determined; d, the maximum vertical distance is determined from multiple vertical distances; e, it is determined whether the maximum vertical distance is less than or equal to a predetermined distance threshold value or not, if the maximum vertical distance is less than or equal to the predetermined distance threshold value, then performing f, and if the maximum vertical distance is greater than the predetermined distance threshold value, then performing g; f other trajectory points other than the first trajectory point and the second trajectory point on the road line may be deleted; g, the road line may be divided into two road sub-lines by using a trajectory point corresponding to the maximum vertical distance as a dividing point. The above-mentioned a to g are performed for the road sub-line until the maximum vertical distance is less than or equal to the predetermined distance threshold value.

According to embodiments of the present disclosure, the performing a road skeleton extraction on the road region image segmentation result to obtain a set of seventh road lines may include the following operations.

A de-noising processing is performed on the road region image segmentation result by using a morphological algorithm, so as to obtain a processed road region image segmentation result. The road skeleton extraction is performed on the processed road region image segmentation result to obtain the set of seventh road lines.

According to embodiments of the present disclosure, a basic idea of a morphological algorithm is to measure and extract a corresponding shape in an image by using a structural element of a certain shape, so as to achieve a purpose of image analysis and recognition. The morphological algorithm may include an opening operation. A de-noising purpose may be achieved by using the opening operation. The opening operation may allow an erosion before a dilation. The dilation may refer to dilating a highlighted portion of an original image, so that an effect image has a larger highlighted region than that in the original image (which is an operation of calculating a local maximum value), that is, the dilation may refer to the operation of calculating the local maximum value. The erosion may refer to eroding the highlighted region of the original image, so that the effect image has a smaller highlighted region than that in the original image, that is, the erosion may refer to an operation of calculating a local minimum value.

According to embodiments of the present disclosure, the processing the set of fifth road lines to obtain a set of sixth road lines may include the following operations.

A road line thinning processing is performed on the set of fifth road lines to obtain a set of eighth road lines. The set of eighth road lines is processed by using a second trajectory point thinning algorithm, so as to obtain a set of ninth road lines. A de-duplication processing is performed on the set of ninth road lines to obtain the set of sixth road lines.

According to embodiments of the present disclosure, the road line thinning processing is performed on the set of fifth road lines by using the erosion in the morphological algorithm, so as to obtain the set of eighth road lines.

According to embodiments of the present disclosure, the second trajectory point thinning algorithm may include the Douglas-Peucker algorithm, a vertical distance limit algorithm or a clustering algorithm.

According to embodiments of the present disclosure, after the set of ninth road lines is obtained, duplicate road lines in the set of ninth road lines may be removed to obtain the set of sixth road lines. For example, the set of sixth road lines may be determined from the set of ninth road lines by using a similarity. The similarity may represent a degree of similarity between two objects. The greater a value of the similarity, the greater the degree of similarity between the two objects, conversely, the smaller the value of the similarity, the smaller the degree of similarity between the two objects. The similarity may be set according to actual task requirements, which is not limited here. For example, the similarity may include a cosine similarity, a Pearson correlation coefficient, a Euclidean distance or a Jaccard distance.

According to embodiments of the present disclosure, a similarity between any two road lines in the set of ninth road lines is determined, so as to obtain a plurality of similarities. For each of the plurality of similarities, in response to determining that the similarity is greater than or equal to a predetermined similarity threshold value, a target road line is determined from two road lines corresponding to the similarity. The set of sixth road lines is obtained according to all target road lines and all the two road lines corresponding to similarities that are less than the similarity threshold value.

According to embodiments of the present disclosure, the combining the set of fourth road lines and the set of sixth road lines to obtain the set of first road lines may include the following operations.

A set of similar road lines is determined. The set of similar road lines includes at least one combination of similar road lines. A target similar road line corresponding to each of the at least one combination of similar road lines is determined, so as to obtain a set of target similar road lines. A set of non-similar road lines is determined. The set of first road lines is obtained according to the set of non-similar road lines and the set of target similar road lines. Each combination of similar road lines includes a first similar road line from the set of fourth road lines and a second similar road line from the set of sixth road lines, and a similarity between the first similar road line and the second similar road line meets a predetermined similarity condition. Each target similar road line is a road line, in each combination of similar road lines, whose length value is greater than that of others in the combination of similar road lines. The set of non-similar road lines is a set of road lines other than the set of similar road lines in the set of fourth road lines and the set of sixth road lines.

According to embodiments of the present disclosure, for each road line in the set of fourth road lines, a similarity between the road line and any road line in the set of sixth road lines is determined. If it is determined that the similarity meeting the predetermined similarity condition exists, the two road lines corresponding to the similarity may be referred to as a combination of similar road lines. A road line from the set of fourth road lines in the combination of similar road lines may be referred to as the first similar road line. A road line from the set of sixth road lines in the combination of similar road lines may be referred to as the second similar road line. The predetermined similarity condition may be used as a basis for determining whether the road line from the set of fourth road lines and the road line from the set of sixth road lines are similar road lines or not. For example, the predetermined similarity condition may include a predetermined similarity threshold value. The similarity meeting the predetermined similarity condition may include the similarity being greater than or equal to the predetermined similarity threshold value.

According to embodiments of the present disclosure, for each combination of similar road lines, the target similar road line may be determined from the combination of similar road lines according to a length value of the road line. For example, a similar road line with a greater length value may be determined from the combination of similar road lines according to the length value of the road line.

According to embodiments of the present disclosure, it is possible to determine a first union of the set of fourth road lines and the set of sixth road lines. A set of road lines in the first union other than the set of similar road lines in the first union is determined as a set of non-similar road lines. It is possible to determine a second union of the set of non-similar road lines and the set of target similar road lines, and the second union may be determined as the set of first road lines.

According to embodiments of the present disclosure, operation S230 may include the following operations.

For each first road line in the set of first road lines, in response to determining that a second road line matched with the first road line exists in the set of second road lines, the first road line is determined as a third road line in the set of third road lines.

According to embodiments of the present disclosure, for each first road line in the set of first road lines, it is possible to determine whether a second road line matched with the first road line exists in the set of second road lines. If it is determined that the second road line matched with the first road line exists in the set of second road lines, then the first road line may be determined as the third road line in the set of third road lines.

According to embodiments of the present disclosure, if it is determined that no second road line matched with the first road line exists in the set of second road lines, then it may be determined that the first road line is not the third road line in the set of third road lines.

According to embodiments of the present disclosure, the determining whether a second road line matched with the first road line exists in the set of second road lines may include: determining a similarity between the first road line and each second road line in the set of second road lines; and determining whether the second road line having the similarity meeting the predetermined similarity condition with the first road line exists in the set of second road lines. If the second road line having the similarity meeting the predetermined similarity condition with the first road line exists in the set of second road lines, then the first road line may be determined as the third road line in the set of third road lines.

According to embodiments of the present disclosure, operation S240 may include the following operations.

A set of road lines having an association with the set of historical road lines is determined from the set of third road lines to obtain a set of valid road lines. The set of valid road lines is determined as the combination result.

According to embodiments of the present disclosure, the having an association may refer to having an intersection between two road lines. For each third road line in the set of third road lines, it may be determined whether the third road line has an association with a historical road line in the set of historical road lines. If it is determined that the third road line has the association with the historical road line in the set of historical road lines, then the third road line may be determined as a valid road line. Thus, the set of valid road lines, that is, the combination result, may be obtained.

According to embodiments of the present disclosure, by combining the set of third road lines and the set of historical road lines, a road line that has an association with the existing road line is retained, and a road line (i.e., an isolated road line) that has no association with the existing road line is removed, thereby retaining the road line with a high validity. In a case of high accuracy, the road line may be automatically constructed and automatically combined with the existing road line.

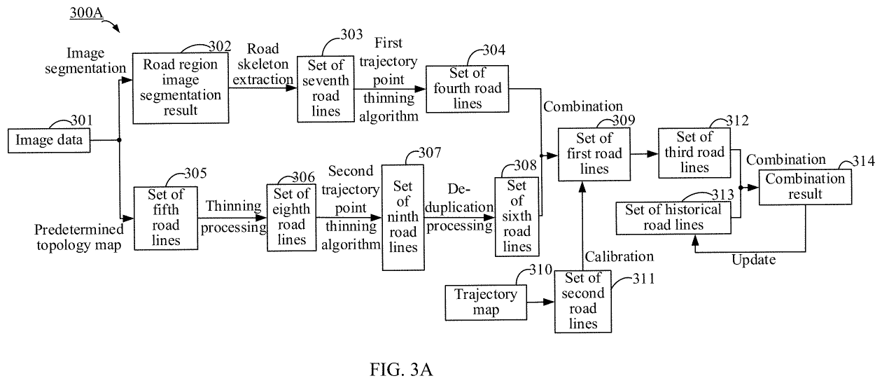

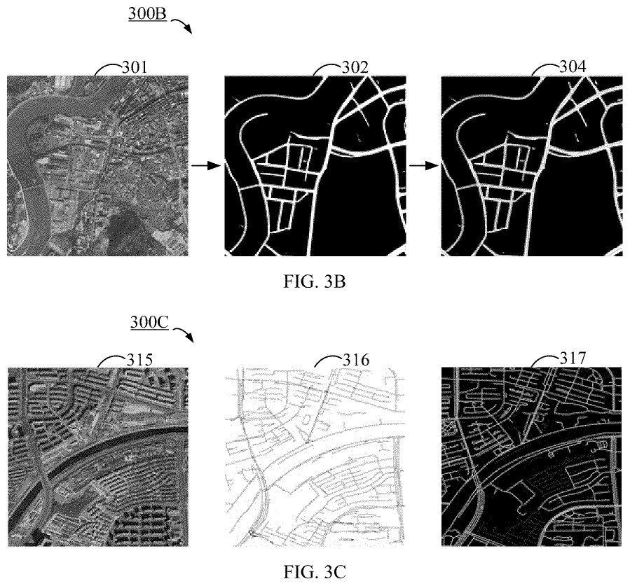

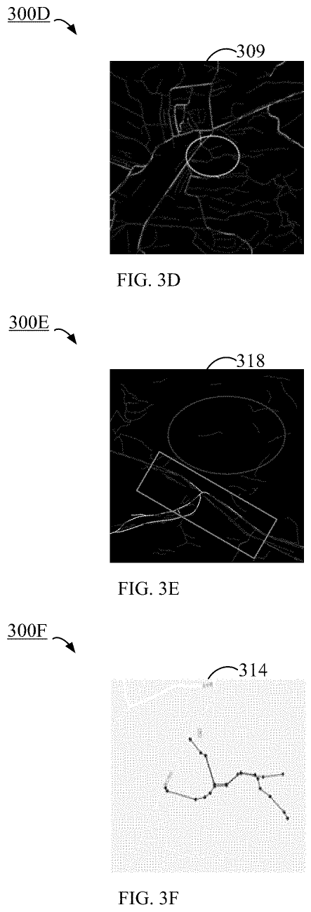

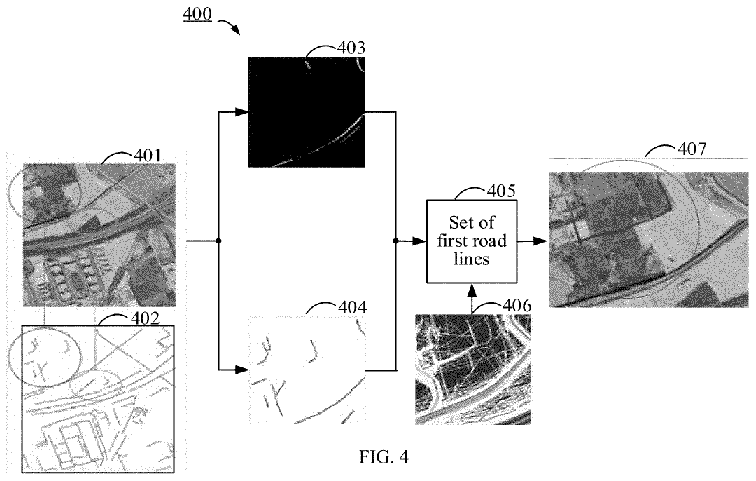

The method of updating the road information according to embodiments of the present disclosure will be further described below with reference to FIG. 3A, FIG. 3B, FIG. 3C, FIG. 3D, FIG. 3E, FIG. 3F and FIG. 4 in combination with specific embodiments.

FIG. 3A schematically shows an exemplary schematic diagram of a process of updating a road information according to an embodiment of the present disclosure.

As shown in FIG. 3A, in a process 300A of updating a road information, an image segmentation is performed on image data 301 corresponding to a target road region to obtain a road region image segmentation result 302. A road skeleton extraction is performed on the road region image segmentation result 302 to obtain a set of seventh road lines 303. The set of seventh road lines 303 is processed by using a first trajectory point thinning algorithm, so as to obtain a set of fourth road lines 304.

The image data 301 is processed by using a predetermined topology map, so as to obtain a set of fifth road lines 305. A road line thinning processing is performed on the set of fifth road lines 305 to obtain a set of eighth road lines 306. The set of eighth road lines 306 is processed by using a second trajectory point thinning algorithm, so as to obtain a set of ninth road lines 307. A de-duplication processing is performed on the set of ninth road lines 307 to obtain a set of sixth road lines 308. The set of fourth road lines 304 and the set of sixth road lines 308 are combined to obtain a set of first road lines 309.

A set of second road lines 311 is obtained according to a trajectory map 310 corresponding to the target road region. The set of first road lines 309 is calibrated by using the set of second road lines 311, so as to obtain a set of third road lines 312. The set of third road lines 312 and a set of historical road lines 313 corresponding to the target road region are combined to obtain a combination result 314. The set of historical road lines 313 is updated according to the combination result 314.

FIG. 3B schematically shows an exemplary schematic diagram of an information related to a set of fourth road lines according to an embodiment of the present disclosure.

As shown in FIG. 3B, in 300B, 301 represents the image data in FIG. 3A. 302 represents the road region image segmentation result in FIG. 3A. 304 represents the set of fourth road lines in FIG. 3A.

FIG. 3C schematically shows an exemplary schematic diagram of an information related to a set of sixth road lines according to an embodiment of the present disclosure.

As shown in FIG. 3C, in 300C, 315 represents image data. 316 represents a set of fifth road lines. 317 represents a set of sixth road lines.

FIG. 3D schematically shows an exemplary schematic diagram of a set of first road lines according to an embodiment of the present disclosure.

As shown in FIG. 3D, in 300D, 309 represents the set of first road lines in FIG. 3A.

FIG. 3E schematically shows an exemplary schematic diagram of a combination process of a set of third road lines and a set of historical road lines according to an embodiment of the present disclosure.

As shown in FIG. 3E, in 300E, a rectangular box region in 318 represents a region where a set of valid road lines is located. An elliptical region in 318 represents a region where a set of invalid road lines is located.

FIG. 3F schematically shows an exemplary schematic diagram of a combination result according to an embodiment of the present disclosure.

As shown in FIG. 3F, in 300F, 314 represents the combination result in FIG. 3A.

FIG. 4 schematically shows an exemplary schematic diagram of a process of updating a road information according to another embodiment of the present disclosure.

As shown in FIG. 4, in a process 400 of updating a road information, 401 represents image data corresponding to a target road region. 402 represents feature extraction data obtained after a feature extraction is performed on the image data 401. A large circle in the feature extraction data 402 represents a missing portion of road lines. A small circle in the feature extraction data 402 represents a redundant portion of the road lines.

An image segmentation is performed on the image data 401 to obtain a road region image segmentation result 403.

The image data 401 is processed by using a predetermined topology map, so as to obtain a set of fifth road lines 404. The road region image segmentation result 403 and the set of fifth road lines 404 are combined to obtain a set of first road lines 405.

A set of second road lines is obtained according to a trajectory map 406 corresponding to the target road region. The set of first road lines 405 is calibrated by using the set of second road lines, so as to obtain a set of third road lines 407. It can be seen from the set of third road lines 407 that the missing portion of the road lines has been supplemented and the redundant portion of the road lines has been deleted.

In the technical solution of the present disclosure, an acquisition, a storage, a use, a processing, a transmission, a provision and a disclosure of user personal information involved comply with provisions of relevant laws and regulations, and do not violate public order and good custom.

In the technical solution of the present disclosure, an authorization or consent of a user is obtained before the user personal information is acquired or collected.

The above are only exemplary embodiments. However, the present disclosure is not limited to this. The present disclosure may also include other methods of updating the road information known in the art, as long as an accuracy and a coverage of the road information update may be improved.

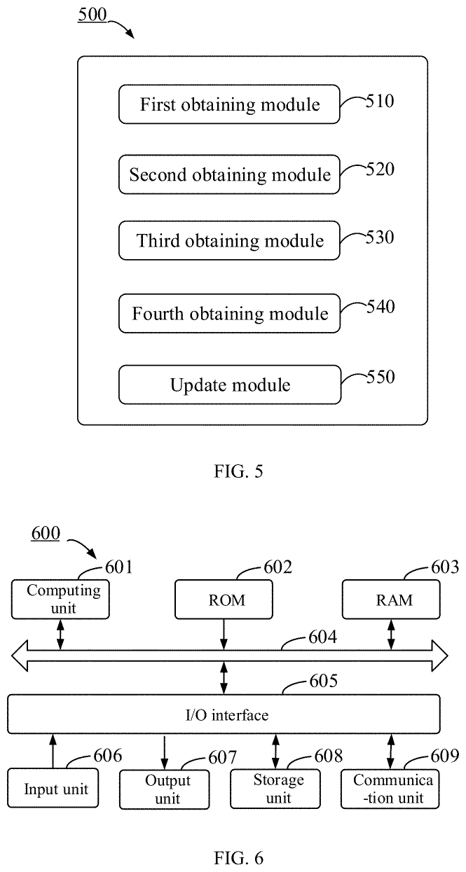

FIG. 5 schematically shows a block diagram of an apparatus of updating a road information according to an embodiment of the present disclosure.

As shown in FIG. 5, an apparatus 500 of updating a road information may include a first obtaining module 510, a second obtaining module 520, a third obtaining module 530, a fourth obtaining module 540, and an update module 550.

The first obtaining module 510 is used to process image data corresponding to a target road region to obtain a set of first road lines.

The second obtaining module 520 is used to obtain a set of second road lines according to a trajectory map corresponding to the target road region.

The third obtaining module 530 is used to calibrate the set of first road lines by using the set of second road lines to obtain a set of third road lines.

The fourth obtaining module 540 is used to combine the set of third road lines and a set of historical road lines corresponding to the target road region to obtain a combination result.

The update module 550 is used to update the set of historical road lines according to the combination result.

According to embodiments of the present disclosure, the first obtaining module 510 may include a first obtaining sub module, a second obtaining sub module and a first determination sub module.

The first obtaining sub module is used to perform an image segmentation on the image data corresponding to the target road region to obtain a road region image segmentation result.

The second obtaining sub module is used to perform a road line extraction on the road region image segmentation result to obtain a set of fourth road lines.

The first determination sub module is used to determine the set of fourth road lines as the set of first road lines.

According to embodiments of the present disclosure, the first obtaining module 510 may further include a third obtaining sub module, a fourth obtaining sub module and a fifth obtaining sub module.

The third obtaining sub module is used to process the image data corresponding to the target road region by using a predetermined topology map, so as to obtain a set of fifth road lines.

The fourth obtaining sub module is used to process the set of fifth road lines to obtain a set of sixth road lines.

The fifth obtaining sub module is used to combine the set of fourth road lines and the set of sixth road lines to obtain the set of first road lines.

According to embodiments of the present disclosure, the second obtaining sub module may include a first obtaining unit and a second obtaining unit.

The first obtaining unit is used to perform a road skeleton extraction on the road region image segmentation result to obtain a set of seventh road lines.

The second obtaining unit is used to process the set of seventh road lines by using a first trajectory point thinning algorithm, so as to obtain the set of fourth road lines.

According to embodiments of the present disclosure, the first obtaining unit may include a first obtaining sub unit and a second obtaining sub unit.

The first obtaining sub unit is used to perform a de-noising processing on the road region image segmentation result by using a morphological algorithm, so as to obtain a processed road region image segmentation result.

The second obtaining sub unit is used to perform the road skeleton extraction on the processed road region image segmentation result to obtain the set of seventh road lines.

According to embodiments of the present disclosure, the fourth obtaining sub module may include a third obtaining unit, a fourth obtaining unit and a fifth obtaining unit.

The third obtaining unit is used to perform a road line thinning processing on the set of fifth road lines to obtain a set of eighth road lines.

The fourth obtaining unit is used to process the set of eighth road lines by using a second trajectory point thinning algorithm, so as to obtain a set of ninth road lines.

The fifth obtaining unit is used to perform a de-duplication processing on the set of ninth road lines to obtain the set of sixth road lines.

According to embodiments of the present disclosure, the fifth obtaining sub module may include a first determination unit, a second determination unit, a third determination unit, and a sixth obtaining unit.

The first determination unit is used to determine a set of similar road lines. The set of similar road lines includes at least one combination of similar road lines.

The second determination unit is used to determine a target similar road line corresponding to each of the at least one combination of similar road lines to obtain a set of target similar road lines.

The third determination unit is used to determine a set of non-similar road lines.

The sixth obtaining unit is used to obtain the set of first road lines according to the set of non-similar road lines and the set of target similar road lines.

According to embodiments of the present disclosure, each combination of similar road lines includes a first similar road line from the set of fourth road lines and a second similar road line from the set of sixth road lines, and a similarity between the first similar road line and the second similar road line meets a predetermined similarity condition.

According to embodiments of the present disclosure, each target similar road line is a road line, in each combination of similar road lines, whose length value is greater than that of other road lines in the combination of similar road lines.

According to embodiments of the present disclosure, the set of non-similar road lines is a set of road lines other than the set of similar road lines in the set of fourth road lines and the set of sixth road lines.

According to embodiments of the present disclosure, the third obtaining module may include a second determination sub module.

The second determination sub module is used to determine, for each first road line in the set of first road lines, the first road line as a third road line in the set of third road lines, in response to determining that a second road line matched with the first road line exists in the set of second road lines.

According to embodiments of the present disclosure, the fourth obtaining module may include a sixth obtaining sub module.

The sixth obtaining sub module is used to determine, from the set of third road lines, a set of road lines having an association with the set of historical road lines to obtain a set of valid road lines.

The third determination sub module is used to determine the set of valid road lines as the combination result.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor, where the memory stores instructions executable by the at least one processor, and the instructions, when executed by the at least one processor, are used to cause the at least one processor to implement the method as described above.

According to embodiments of the present disclosure, a non-transitory computer-readable storage medium having computer instructions therein is provided, and the computer instructions are used to cause a computer system to implement the method as described above.

According to embodiments of the present disclosure, a computer program product containing a computer program is provided, and the computer program, when executed by a processor, is configured to cause the processor to implement the method as described above.

FIG. 6 schematically shows a block diagram of an electronic device suitable for implementing a method of updating a road information according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 includes a computing unit 601 which may perform various appropriate actions and processes according to a computer program stored in a read only memory (ROM) 602 or a computer program loaded from a storage unit 608 into a random access memory (RAM) 603. In the RAM 603, various programs and data necessary for an operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and steps described above, such as the method of updating the road information. For example, in some embodiments, the method of updating the road information may be implemented as a computer software program which is tangibly embodied in a machine-readable medium, such as the storage unit 608. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the method of updating the road information described above. Alternatively, in other embodiments, the computing unit 601 may be configured to perform the method of updating the road information by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those of ordinary skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of updating a road information, comprising:
processing image data corresponding to a target road region to obtain a set of first road lines;
obtaining a set of second road lines according to a trajectory map corresponding to the target road region;
calibrating the set of first road lines by using the set of second road lines to obtain a set of third road lines;
combining the set of third road lines and a set of historical road lines to obtain a combination result, wherein the set of historical road lines corresponds to the target road region; and
updating the set of historical road lines according to the combination result.

2. The method according to claim 1, wherein the processing image data corresponding to a target road region to obtain a set of first road lines comprises:
performing an image segmentation on the image data corresponding to the target road region to obtain a road region image segmentation result;
performing a road line extraction on the road region image segmentation result to obtain a set of fourth road lines; and
determining the set of fourth road lines as the set of first road lines.

3. The method according to claim 2, wherein the processing image data corresponding to a target road region to obtain a set of first road lines further comprises:
processing the image data corresponding to the target road region by using a predetermined topology map, so as to obtain a set of fifth road lines;
processing the set of fifth road lines to obtain a set of sixth road lines; and
combining the set of fourth road lines and the set of sixth road lines to obtain the set of first road lines.

4. The method according to claim 2, wherein the performing a road line extraction on the road region image segmentation result to obtain a set of fourth road lines comprises:
performing a road skeleton extraction on the road region image segmentation result to obtain a set of seventh road lines; and
processing the set of seventh road lines by using a first trajectory point thinning algorithm, so as to obtain the set of fourth road lines.

5. The method according to claim 4, wherein the performing a road skeleton extraction on the road region image segmentation result to obtain a set of seventh road lines comprises:
performing a de-noising processing on the road region image segmentation result by using a morphological algorithm, so as to obtain a processed road region image segmentation result; and
performing the road skeleton extraction on the processed road region image segmentation result to obtain the set of seventh road lines.

6. The method according to claim 3, wherein the processing the set of fifth road lines to obtain a set of sixth road lines comprises:
performing a road line thinning processing on the set of fifth road lines to obtain a set of eighth road lines;
processing the set of eighth road lines by using a second trajectory point thinning algorithm, so as to obtain a set of ninth road lines; and
performing a de-duplication processing on the set of ninth road lines to obtain the set of sixth road lines.

7. The method according to claim 3, wherein the combining the set of fourth road lines and the set of sixth road lines to obtain the set of first road lines comprises:
determining a set of similar road lines, wherein the set of similar road lines comprises at least one combination of similar road lines;
determining a target similar road line corresponding to each of the at least one combination of similar road lines so as to obtain a set of target similar road lines;
determining a set of non-similar road lines; and
obtaining the set of first road lines according to the set of non-similar road lines and the set of target similar road lines,
wherein each combination of similar road lines comprises a first similar road line from the set of fourth road lines and a second similar road line from the set of sixth road lines, and a similarity between the first similar road line and the second similar road line meets a predetermined similarity condition, and
wherein each target similar road line is a road line, in each combination of similar road lines, whose length value is greater than that of other road lines in the combination of similar road lines, and
wherein the set of non-similar road lines is a set of road lines other than the set of similar road lines in the set of fourth road lines and the set of sixth road lines.

8. The method according to claim 1, wherein the calibrating the set of first road lines by using the set of second road lines so as to obtain a set of third road lines comprises:
determining, for each first road line in the set of first road lines, the first road line as a third road line in the set of third road lines, in response to determining that a second road line matched with the first road line exists in the set of second road lines.

9. The method according to claim 1, wherein combining the set of third road lines and the set of historical road lines corresponding to the target road region to obtain the combination result comprises:
determining, from the set of third road lines, a set of road lines having an association with the set of historical road lines to obtain a set of valid road lines; and
determining the set of valid road lines as the combination result.

10. The method according to claim 3, wherein the performing a road line extraction on the road region image segmentation result to obtain a set of fourth road lines comprises:
performing a road skeleton extraction on the road region image segmentation result to obtain a set of seventh road lines; and
processing the set of seventh road lines by using a first trajectory point thinning algorithm, so as to obtain the set of fourth road lines.

11. An electronic device, comprising:
at least one processor; and
a memory communicatively connected to the at least one processor, wherein
the memory stores instructions executable by the at least one processor, and the instructions, when executed by the at least one processor, are configured to cause the at least one processor to at least:
process image data corresponding to a target road region to obtain a set of first road lines;
obtain a set of second road lines according to a trajectory map corresponding to the target road region;
calibrate the set of first road lines by using the set of second road lines to obtain a set of third road lines;
combine the set of third road lines and a set of historical road lines to obtain a combination result, wherein the set of historical road lines corresponds to the target road region; and
update the set of historical road lines according to the combination result.

12. The electronic device according to claim 11, wherein the instructions are further configured to cause the at least one processor to at least:
perform an image segmentation on the image data corresponding to the target road region to obtain a road region image segmentation result;
perform a road line extraction on the road region image segmentation result to obtain a set of fourth road lines; and
determine the set of fourth road lines as the set of first road lines.

13. The electronic device according to claim 12, wherein the instructions are further configured to cause the at least one processor to at least:
process the image data corresponding to the target road region by using a predetermined topology map, so as to obtain a set of fifth road lines;
process the set of fifth road lines to obtain a set of sixth road lines; and
combine the set of fourth road lines and the set of sixth road lines to obtain the set of first road lines.

14. The electronic device according to claim 12, wherein the instructions are further configured to cause the at least one processor to at least:
perform a road skeleton extraction on the road region image segmentation result to obtain a set of seventh road lines; and
process the set of seventh road lines by using a first trajectory point thinning algorithm, so as to obtain the set of fourth road lines.

15. The electronic device according to claim 14, wherein the instructions are further configured to cause the at least one processor to at least:
perform a de-noising processing on the road region image segmentation result by using a morphological algorithm, so as to obtain a processed road region image segmentation result; and
perform the road skeleton extraction on the processed road region image segmentation result to obtain the set of seventh road lines.

16. The electronic device according to claim 13, wherein the instructions are further configured to cause the at least one processor to at least:
perform a road line thinning processing on the set of fifth road lines to obtain a set of eighth road lines;
process the set of eighth road lines by using a second trajectory point thinning algorithm, so as to obtain a set of ninth road lines; and
perform a de-duplication processing on the set of ninth road lines to obtain the set of sixth road lines.

17. The electronic device according to claim 13, wherein the instructions are further configured to cause the at least one processor to at least:
determine a set of similar road lines, wherein the set of similar road lines comprises at least one combination of similar road lines;
determine a target similar road line corresponding to each of the at least one combination of similar road lines so as to obtain a set of target similar road lines;
determine a set of non-similar road lines; and
obtain the set of first road lines according to the set of non-similar road lines and the set of target similar road lines,
wherein each combination of similar road lines comprises a first similar road line from the set of fourth road lines and a second similar road line from the set of sixth road lines, and a similarity between the first similar road line and the second similar road line meets a predetermined similarity condition, and
wherein each target similar road line is a road line, in each combination of similar road lines, whose length value is greater than that of other road lines in the combination of similar road lines, and
wherein the set of non-similar road lines is a set of road lines other than the set of similar road lines in the set of fourth road lines and the set of sixth road lines.

18. The electronic device according to claim 11, wherein the instructions are further configured to cause the at least one processor to at least:
determine, for each first road line in the set of first road lines, the first road line as a third road line in the set of third road lines, in response to determining that a second road line matched with the first road line exists in the set of second road lines.

19. The electronic device according to claim 11, wherein the instructions are further configured to cause the at least one processor to at least:
determine, from the set of third road lines, a set of road lines having an association with the set of historical road lines to obtain a set of valid road lines; and
determine the set of valid road lines as the combination result.

20. A non-transitory computer-readable storage medium having computer instructions therein, wherein the computer instructions are configured to cause a computer system to at least:
process image data corresponding to a target road region to obtain a set of first road lines;
obtain a set of second road lines according to a trajectory map corresponding to the target road region;
calibrate the set of first road lines by using the set of second road lines to obtain a set of third road lines;
combine the set of third road lines and a set of historical road lines to obtain a combination result, wherein the set of historical road lines corresponds to the target road region; and
update the set of historical road lines according to the combination result.
